(19) United States
(12) Patent Application Publication
(10) Pub. No.: US 2013/0167417 A1
(43) Pub. Date: Jul. 4, 2013

(54) PICTURE FRAME ASSEMBLY

(71) Applicant: Thomas Vincent, Salt Spring Island (CA)

(72) Inventor: Thomas Vincent, Salt Spring Island (CA)

(73) Assignee: UMBRA LLC, Buffalo, NY (US)

(21) Appl. No.: 13/340,174

(22) Filed: Dec. 29, 2011

(51) Int. Cl. A47G 1/06; B23P 11/00

(52) U.S. Cl. 40/729; 29/428

(57) ABSTRACT

A picture frame assembly, including: a first picture frame including a first connecting element, located at a first end of the first picture frame, and extending away from the first end, the first end including a first surface facing an interior of the first picture frame; and a second picture frame including a second connecting element, located at a second end of the second picture frame, and extending away from the second end, the second end including a second surface facing an interior of the second picture frame. The first connecting element is engaged with the second surface. The second connecting element is engaged with the first surface. The first and second picture frames are fixed to each other via the contact of the first and second connecting elements with the second and first picture frames, respectively.

### FIELD OF THE INVENTION

The invention relates generally to an assembly of interconnected picture frames.

### BACKGROUND OF THE INVENTION

It is known to create a presentation of multiple individual picture frames by hanging each frame separately. Unfortunately, this requires providing respective hanging means for each frame, for example, drilling respective holes for wall hanging each frame. It also is known to minimize the space required for displaying multiple picture frames by individually mounting each frame as close to the remaining frames as possible. Unfortunately, not only does this require providing multiple hanging means, but a great deal of precision is required in order to mount the frames as close as possible to each other and in relative alignment with each other. Further, since the frames are all separate, it is difficult to maintain relative alignment.

### SUMMARY OF THE INVENTION

The invention broadly comprises a picture frame assembly, including: a first picture frame including a first connecting element, located at a first end of the first picture frame, and extending away from the first end, the first end including a first surface facing an interior of the first picture frame; and a second picture frame including a second connecting element, located at a second end of the second picture frame, and extending away from the second end, the second end including a second surface facing an interior of the second picture frame. The first connecting element is engaged with the second surface. The second connecting element is engaged with the first surface. The first and second picture frames are fixed to each other via the contact of the first and second connecting elements with the second and first picture frames, respectively.

The invention broadly comprises a picture frame assembly, including: a first picture frame including a first end with a first outwardly facing surface; and a first connecting element including a first portion extending away from the first outwardly facing surface, a second portion extending from the first portion, and a first protrusion extending from the second portion toward an interior of the first picture frame. The assembly includes a second picture frame including a second end with a second outwardly facing surface; and a second connecting element including a third portion extending away from the second outwardly facing surface, a fourth portion extending from the third portion, and a second protrusion extending from the fourth portion toward an interior of the second picture frame. The first and second picture frames are arranged to lockingly engage by engaging the first and second protrusions with the second and first ends, respectively.

The invention broadly comprises a method of joining first and second picture frames, the first picture frame including a first outwardly facing surface with a first connecting element having a first portion extending outward from the first outwardly facing surface and a second portion extending from the first portion, and a first inwardly facing surface with a first indentation, and the second picture frame including a second outwardly facing surface with a second connecting element having a third portion extending outward from the second outwardly facing surface and a fourth portion extending from the third portion, and a second inwardly facing surface with a second indentation, the method including: placing the first and second outwardly facing surfaces in contact such that respective longitudinal axis for the first and second outwardly facing surfaces are at an acute angle with respect to each other; swiveling the first and second picture frames to reduce the acute angle and bring the second and fourth portions in contact with the second and first picture frames, respectively; continue swiveling the first and second picture frames to reduce the acute angle and to slide the second and fourth portions across the second and first inwardly facing surfaces respectively; and continue swiveling the first and second picture frames until the respective axis are parallel and the second and fourth portions engage the second and first indentations.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of a picture frame assembly;

FIG. 2 is a front perspective view of a group of picture frame assemblies;

FIG. 3 is a back prospective view of a picture frame in FIG. 1;

FIG. 3A is a detail if area 3A in FIG. 3;

FIG. 3B is a detail of area 3B in FIG. 3;

FIG. 4 is a back exploded view of the picture frame assembly of FIG. 1;

FIG. 4A is a detail of area 4A/4B in FIG. 4 with picture frames disengaged;

FIG. 4B is a detail of area 4A/4B in FIG. 4 with picture frames engaged;

FIG. 5 is a back view of the picture frame assembly of FIG. 1;

FIG. 5A is a detail of area 5A in FIG. 5;

FIG. 5B is a detail of area 5B in FIG. 5; and,

FIGS. 6A through 6D show a sequence of assembling and disassembling the picture frame assembly of FIG. 1.

### DETAILED DESCRIPTION OF THE INVENTION

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

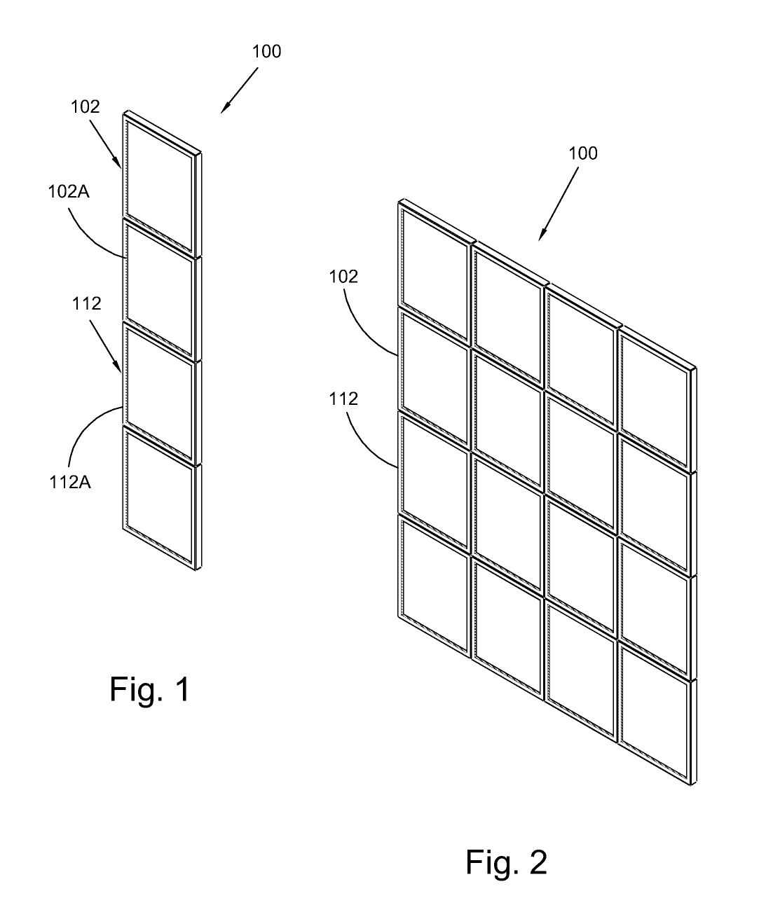

FIG. 1 is a front perspective view of a picture frame assembly 100.

FIG. 2 is a front perspective view of a group of picture frame assemblies 100.

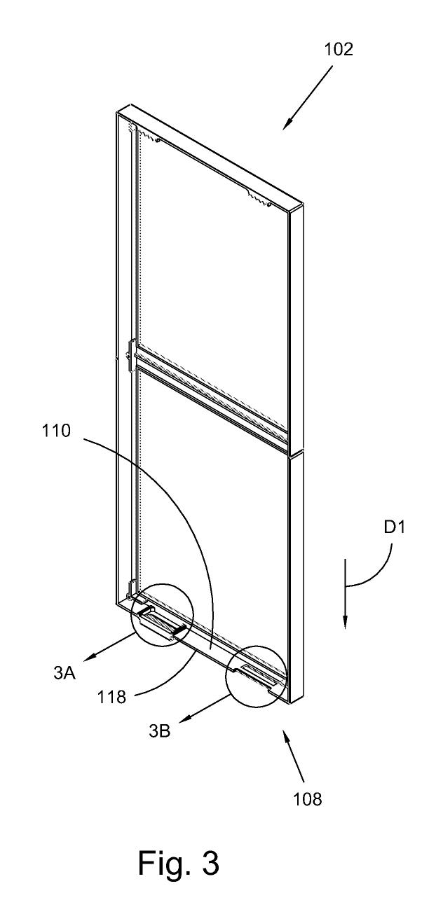

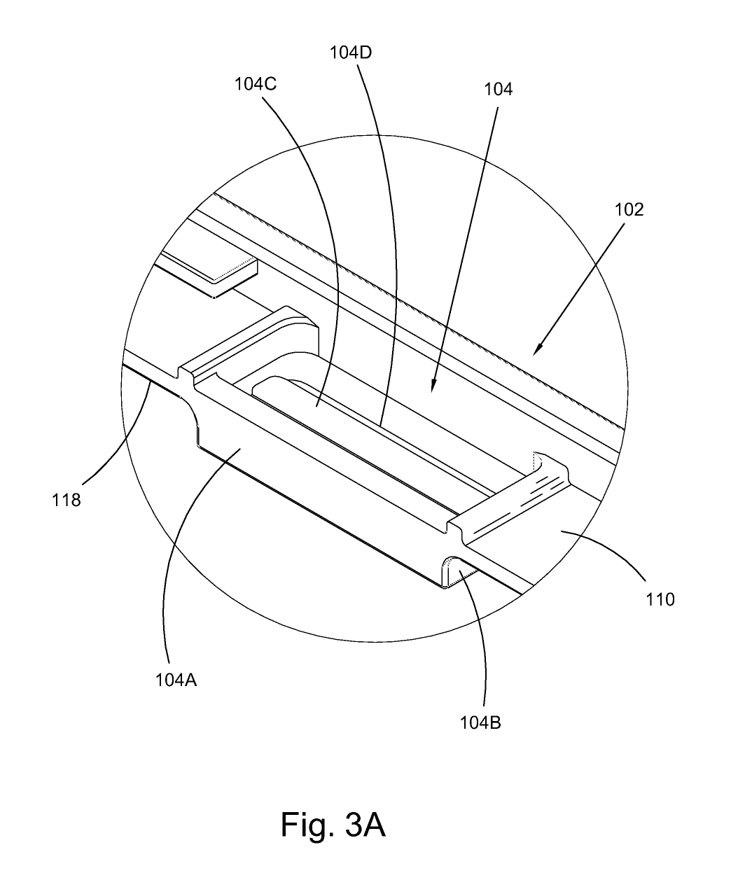

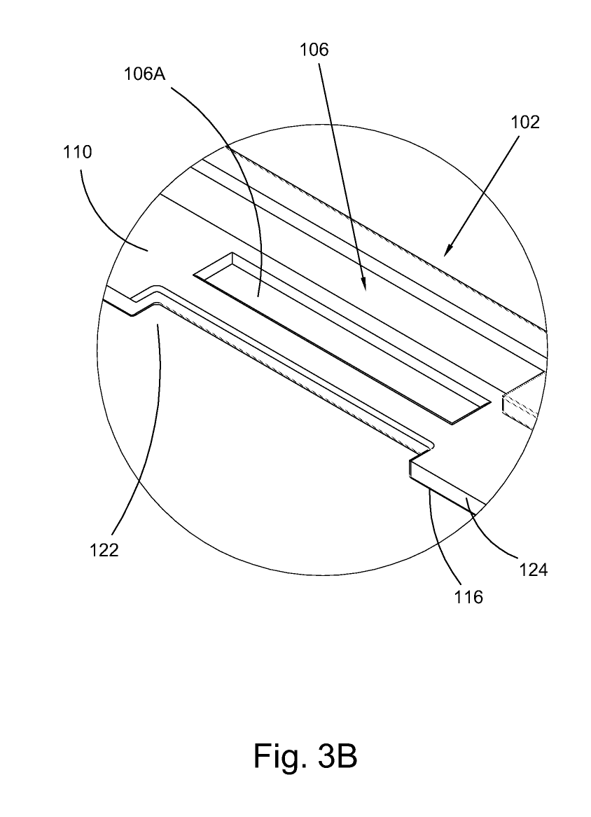

FIG. 3 is a back prospective view of picture frame 102 in FIG. 1.

FIG. 3A is a detail if area 3A in FIG. 3.

FIG. 3B is a detail of area 3B in FIG. 3.

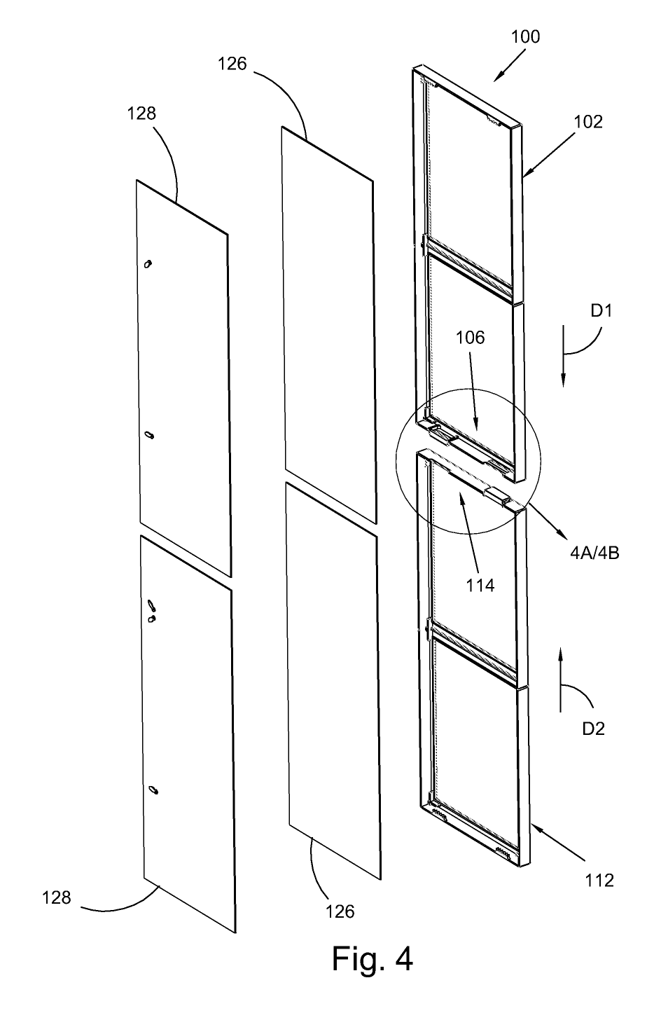

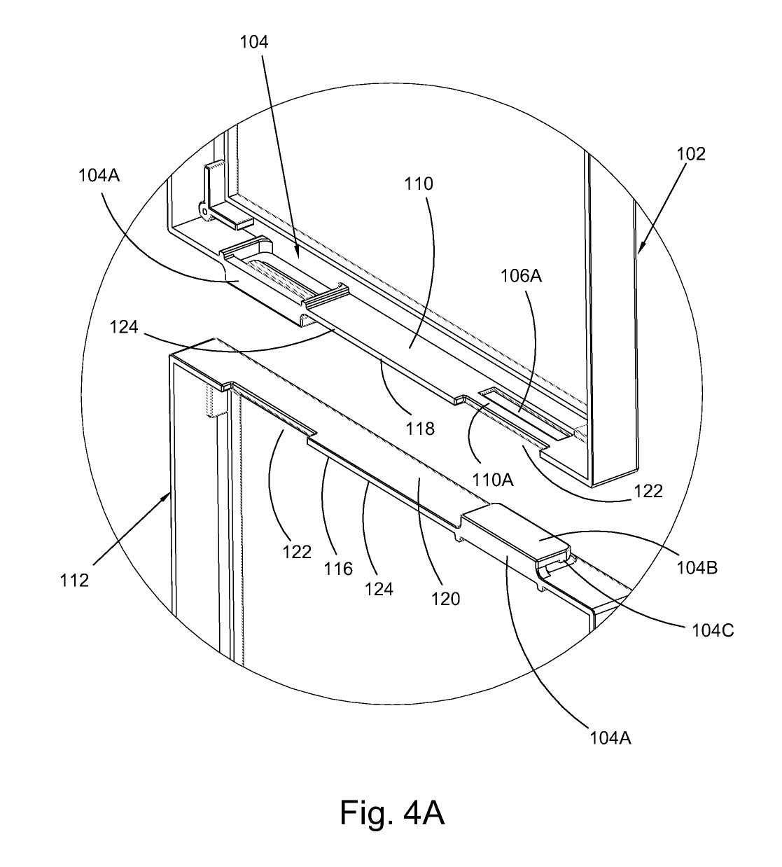

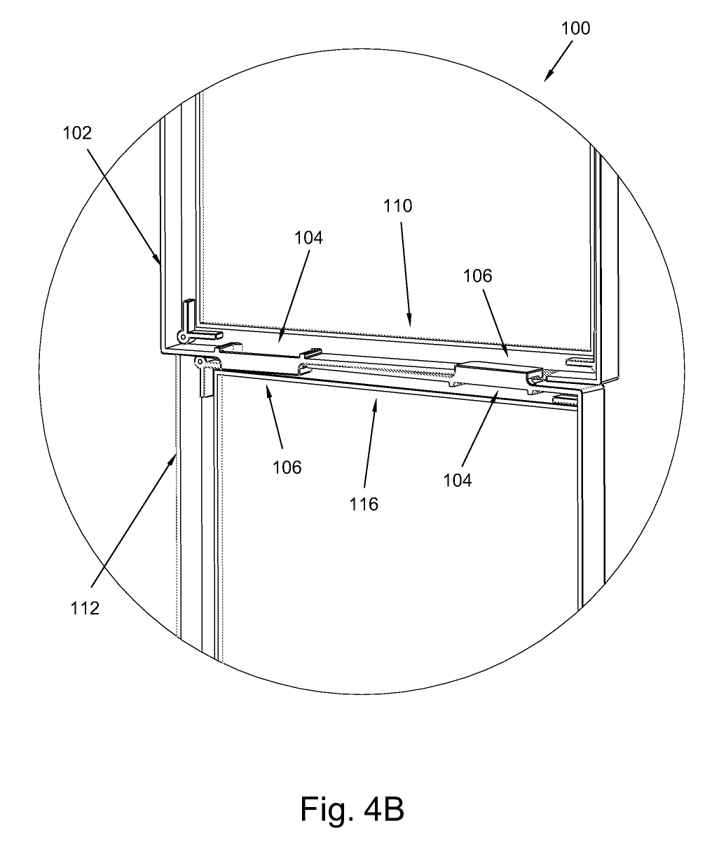

FIG. 4 is a back exploded view of picture frame assembly 100 of FIG. 1.

FIG. 4A is a detail of area 4A/4B in FIG. 4 with picture frames 102 and 112 disengaged.

FIG. 4B is a detail of area 4A/4B in FIG. 4 with picture frames 102 and 112 engaged. The following should be viewed in light of FIGS. 1 through 4B. Picture frame assembly 100 includes picture frame 102 including connecting elements 104 and 106, located at end 108 of picture frame 102. Element 104 in frame 102 extends away from end 108 in direction D1. End 108 includes surface 110 facing the interior of picture frame 102, that is, the space enclosed by the picture frame. Assembly 100 includes picture frame 112 with connecting elements 104 and 106 at end 114. Element 104 in frame 112 extends away end 114. End 114 includes surface 116 facing the interior of picture frame 112, that is, the space enclosed by the picture frame. Elements 104 in frames 102 and 112 are engaged with surfaces 110 and 116, respectively, in assembly 100, and picture frames 102 and 112 are fixed to each other via the contact of elements 104 and 106 for frame 102 with elements 106 and 104, respectively, for frame 112, as further described below.

Ends 108 and 114 include surfaces 118 and 120, respectively, facing away from the interiors of frames 102 and 112, respectively. Element 104 on frame 102 includes portion 104A extending from surface 118 and toward picture frame 112, for example, in direction D1. Element 104 on frame 112 includes portion 104A extending from surface 120 and toward picture frame 102, for example, in direction D2. Portion 104A includes portion 104B extending from portion 104A. In an example embodiment, surfaces 118 and 120 are in contact in assembly 100. In an example embodiment, ends 106 and 114 include cut outs 122 and portions 104A are at least partially disposed in respective cut outs.

In an example embodiment, portions 104B include protrusions 104C extending toward the picture frame for element 104. For example, protrusion 104C in element 104 on frame 102 extends in direction D2 toward frame 102. In an example embodiment, elements 106 include indentations 106A engaged with respective protrusions 104C in assembly 100. In an example embodiment, openings through ends 106 and 114 replace indentations 106A. Thus, protrusion 104C for frame 102 is engaged with indentation 106A for frame 112. In an example embodiment, respective protrusions 104C are in compressive engagement with respective indentations 106A.

In an example embodiment, surfaces 110 and 118 include lips 110A separating indentations 106A from edges 124 of frames 102 and 112. Lips 110A are at least partially sandwiched between portions 104A and protrusions 104C in assembly 100. In an example embodiment, portions 104A and/or portions 104B are flexible to enable protrusions 104C to slide across surface 110 or 116 to slide into or out of indentations 106A, as further described below. In an example embodiment ends, 106 and 114, in particular, elements 104, include openings 104D passing through the ends 106 or 114. Portions 104C are accessible through openings 104D, for example, as shown in FIG. 3A. In an example embodiment, via the access through openings 104D, portions 104B are displaceable to at least partially disengage protrusions 104C from indentations 106A. For example, portion 104B in frame 102 can be pushed in direction D1, through opening 104D to likewise displace protrusion in direction D1 out of indentation 106A in frame 112.

In an example embodiment, frames 102 and 112 are co-planar. For example, front surfaces 102A and 112A lie in a same plane. As shown in FIG. 2, two or more assemblies 100 can be placed side-by-side to create a larger display area.

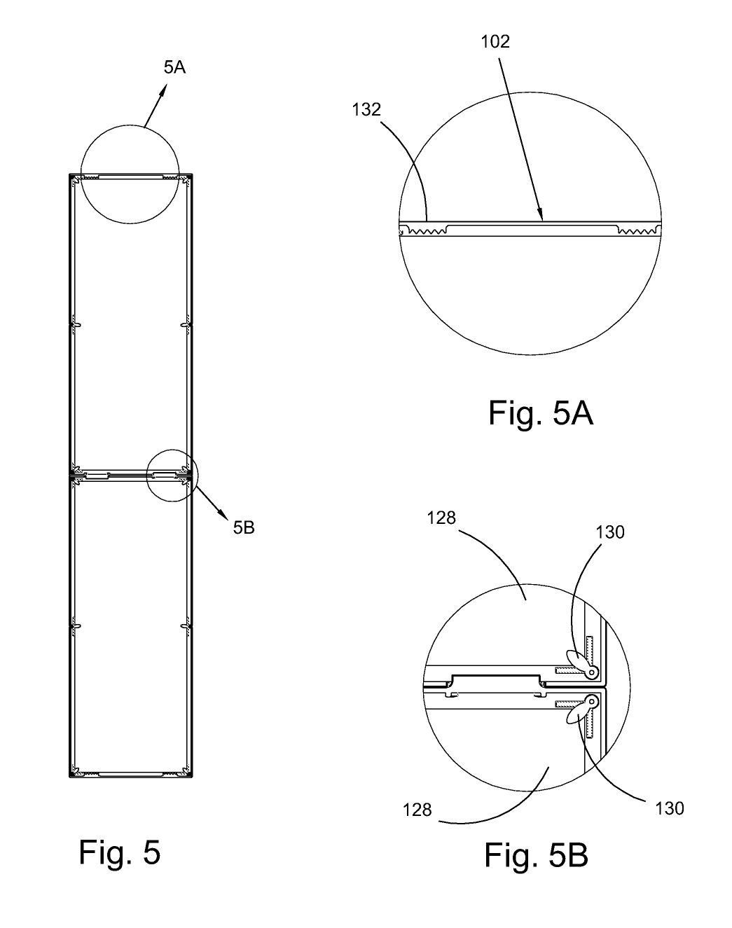

FIG. 5 is a back view of picture frame assembly 100 of FIG. 1.

FIG. 5A is a detail of area 5A in FIG. 5.

FIG. 5B is a detail of area 5B in FIG. 5. The following should be viewed in light of FIGS. 1 through 5B and provides further detail regarding assembly 100. As shown in FIG. 4, in an example embodiment, frames 102 and 112 includes clear panes 126, made of any material known in the art, for example, glass or plastic. In an example embodiment, frames 102 and 112 include backing members 128. In use, a picture or pictures can be sandwiched between panes 126 and members 128. In an example embodiment, pivot members 130 are used to hold members 128 in place. In an example embodiment, mounting features 132 on frame 102 are usable to affix assembly 100 to a wall or other surface.

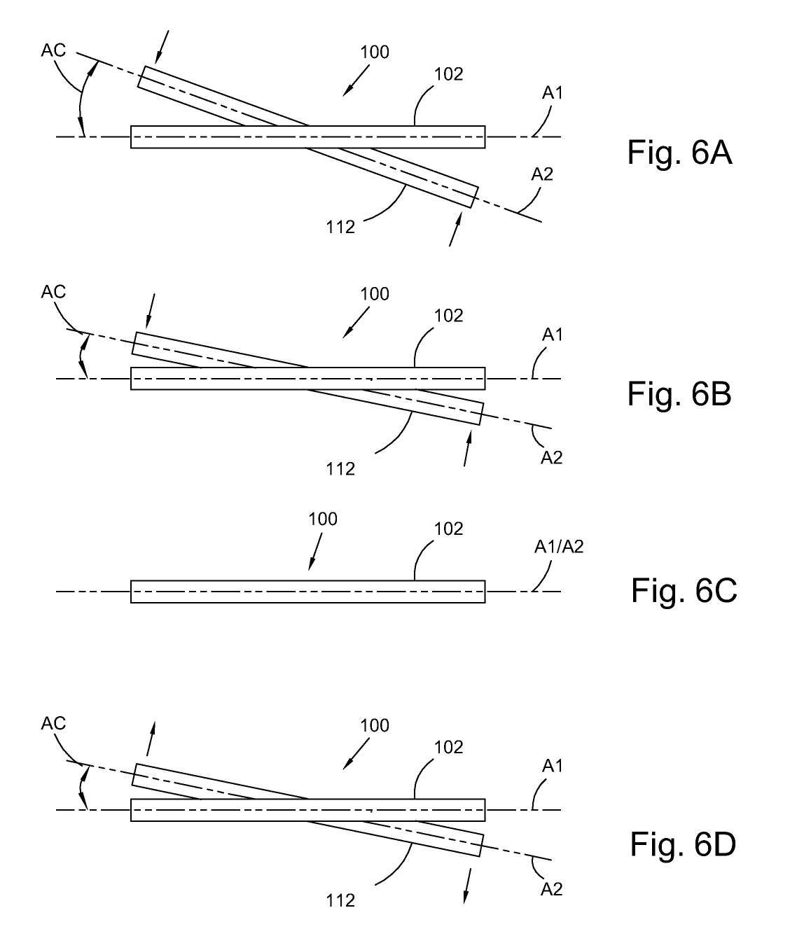

FIGS. 6A through 6D show a sequence of assembling and disassembling picture frame assembly 100 of FIG. 1. The following should be viewed in light of FIGS. 1 through 6D and provides further detail regarding the assembling and disassembling of assembly 100. As shown in FIG. 6A, frames 102 and 112 are positioned such that surfaces 118 and 120 are in contact and longitudinal axis A1 and A2, for ends 106 and 114, respectively, are at acute angle AC with respect to each other. In FIG. 6B, frames 102 and 112 are swiveled to reduce the acute angle and bring portions 104 for frames 102 and 112, respectively, into contact with frames 112 and 102, respectively. Frames 102 and 112 are swiveled further until the respective axis are parallel, as shown in FIG. 6C and FIGS. 1-3 and respective elements 104 engage respective elements 106 as described above, for example, respective protrusions 104C engage respective indentations 106A.

Swiveling frames 102 and 112 to reduce AC results in respective portions 104A moving into respective cutouts 122. Swiveling frames 102 and 112 such that axis A1 and A2 are parallel results in respective protrusions 104C engaging respective indentations 106A. In order for protrusions 104C to engage indentations 106A, the protrusions slide across surfaces 110 and 116 to sandwich lips 110A between portions 104A and protrusions 104C.

To disassembly frames 102 and 112, respective portions 104B are accessed through respective openings 104D and displaced from respective indentation 106A. For example, portion 104B for frame 102 is displaced in direction D1. As shown in FIG. 6D, frames 102 and 112 are swiveled to increase angle AC such that respective portions 104 and 106 are disengaged, enabling frames 102 and 112 to be separately moved.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

1. A picture frame assembly, comprising:
a first picture frame including a first connecting element, located at a first end of the first picture frame, and extending away from the first end, the first end including a first surface facing an interior of the first picture frame; and,
a second picture frame including a second connecting element, located at a second end of the second picture frame, and extending away from the second end, the second end including a second surface facing an interior of the second picture frame, wherein:
the first connecting element is engaged with the second surface;
the second connecting element is engaged with the first surface;
the first and second picture frames are fixed to each other via the contact of the first and second connecting elements with the second and first picture frames, respectively;
the first and second ends include third and fourth surfaces, respectively, facing away from the interiors of the first and second picture frames, respectively;
the first and second connecting elements include first and second portions, respectively, extending from the third and fourth surfaces toward the second and first picture frames, respectively; the first and second connecting elements include third and fourth portions, respectively, extending from the first and second portions, respectively;
the first and second ends includes first and second cut outs, respectively;
the first portion is at least partially disposed in the second cut out and,
the second portion is at least partially disposed in the first cut out.

2. (canceled)

3. The picture frame assembly of claim 1 wherein the third and fourth surfaces are in contact.

4. (canceled)

5. The picture frame assembly of claim 1 wherein:
the third and fourth portions include first and second protrusions, respectively, extending toward the first and second picture frames, respectively; and,
the first and second surfaces include first and second indentations, respectively, engaged with the second and first protrusions, respectively.

6. The picture frame assembly of claim 5 wherein the first and second protrusions are in compressive engagement with the second and first ends, respectively.

7. The picture frame assembly of claim 5 wherein:
the first and second surfaces include first and second lips, respectively, separating the first and second indentations from first and second edges of the first and second ends, respectively;
the first lip is at least partially sandwiched between the second portion and the second protrusion; and,
the second lip is at least partially sandwiched between the first portion and the first protrusion.

8. The picture frame assembly of claim 5 wherein:
the first and second surfaces include first and second lips, respectively, separating the first and second indentations from first and second edges of the first and second ends, respectively;
the first or third portion is flexible to enable the first protrusion to slide across the fourth surface to slide into or out of the second indentation; and,
the second or fourth portion is flexible to enable the second protrusion to slide across the third surface to slide into or out of the first indentation.

9. The picture frame assembly of claim 5 wherein:
the first and second ends include first and second openings, respectively, passing through the first and second ends, respectively; and,
the third and fourth portions are accessible through the second and first openings, respectively.

10. The picture frame assembly of claim 9 wherein via the access through the second and first openings, respectively, the third and fourth portions are displaceable to at least partially disengage the first and second protrusions from the second and first indentations, respectively.

11. The picture frame assembly of claim 1 wherein the first and second picture frames are co-planar.

12. A picture frame assembly, comprising:
a first picture frame including a first end with:
a first outwardly facing surface; and,
a first connecting element including a first portion extending away from the first outwardly facing surface, a second portion extending from the first portion, and a first protrusion extending from the second portion toward an interior of the first picture frame; and,
a second picture frame including a second end with:
a second outwardly facing surface; and,
a second connecting element including a third portion extending away from the second outwardly facing surface, a fourth portion extending from the third portion, and a second protrusion extending from the fourth portion toward an interior of the second picture frame, wherein:
the first and second picture frames are arranged to lockingly engage by engaging the first and second protrusions with the second and first ends, respectively.

13. The picture frame assembly of claim 12 wherein:
the first protrusion intersects a first plane formed by the first outwardly facing surface; and,
the second protrusion intersects a second plane formed by the second outwardly facing surface.

14. The picture frame assembly of claim 12 wherein:
the first and second ends include first and second inwardly facing surfaces, respectively, with first and second indentations, respectively;
the first connecting element is centered at a first distance from a center point along a longitudinal axis for the first end;
the second indentation is centered at a second distance from a center point along a longitudinal axis for the second end; and,
the first distance is approximately equal to the second distance.

15. The picture frame assembly of claim 12 wherein:
the first and second ends include first and second openings, respectively, passing through the first and second ends, respectively; and,
the first and second protrusions are aligned with the first and second openings, respectively.

16. A method of joining first and second picture frames, the first picture frame including a first outwardly facing surface with a first connecting element having a first portion extending outward from the first outwardly facing surface and a second portion extending from the first portion, and a first inwardly facing surface with a first indentation, and the second picture frame including a second outwardly facing surface with a second connecting element having a third portion extending outward from the second outwardly facing surface and a fourth portion extending from the third portion, and a second inwardly facing surface with a second indentation, the method comprising:
placing the first and second outwardly facing surfaces in contact such that respective longitudinal axis for the first and second outwardly facing surfaces are at an acute angle with respect to each other;
swiveling the first and second picture frames to reduce the acute angle and bring the second and fourth portions in contact with the second and first picture frames, respectively;
continue swiveling the first and second picture frames to reduce the acute angle and to slide the second and fourth portions across the second and first inwardly facing surfaces respectively; and,
continue swiveling the first and second picture frames until the respective axis are parallel and the second and fourth portions engage the second and first indentations.

17. The method of claim 16 wherein:
the first and second picture frames include first and second cut outs, respectively; and,
continuing to swivel the first and second picture frames until the respective axis are parallel includes disposing the first and third portions in the second and first cutouts, respectively.

18. The method of claim 16 wherein continuing to swivel the first and second picture frames until the respective axis are parallel and the second and fourth portions engage the second and first indentations includes compressively engaging the second and fourth portions with the second and first indentations, respectively.

19. The method of claim 16 wherein:
the first and second inwardly facing surfaces include first and second lips, respectively, forming at least respective portions of the first and second indentations; and,
continuing to swivel the first and second picture frames until the respective axis are parallel and the second and fourth portions engage the second and first indentations includes:
sandwiching the first lip at least partially between the third and fourth portions; and,
sandwiching the second lip is at least partially between the first and second portions.

20. The method of claim 16 wherein the first and second inwardly facing surfaces include first and second openings, respectively, passing through the first and second picture frames, respectively, the method further comprising:
accessing the second and fourth portions through the first and second openings, respectively;
displacing the second portion to at least partially disengage the second portion from the second indentation;
displacing the fourth portion to at least partially disengage the fourth portion from the first indentation;
swiveling the first and second picture frames to slide the second and fourth portions across the second and first inwardly facing surfaces respectively; and,
continuing to swivel the first and second picture frames such that the second and fourth portions are free of contact with the second and first picture frames, respectively.
